(19) United States
(12) Patent Application Publication
(10) Pub. No.: US 2008/0055079 A1
(43) Pub. Date: Mar. 6, 2008

(54) Alarm system with air pressure detector

(76) Inventor: Jacob Fraden, San Diego, CA (US)

Correspondence Address: Jacob Fraden, Ste. 125, 6215 Ferris Sq., San Diego, CA, 92121, US

(21) Appl. No.: 11/897,341

(22) Filed: Aug. 31, 2007

Related U.S. Application Data
(60) Provisional application No. 60/842,522, filed on Sep. 6, 2006.

(51) Int. Cl. G08B 13/20

(52) U.S. Cl. 340/544

(57) ABSTRACT

An intrusion alarm system in which intrusion into an protected space is detected as a variation in air pressure. The variable pressure detector uses a membrane and a displacement detector. One side of the membrane is exposed to the protected space and the opposite side of the membrane is enveloped by an enclosure with a limited pressure coupling to the protected space. A signal from the displacement detector is analyzed by a processor to identify rapid changes in air pressure to activate the security alarm. The same type of a variable pressure detector may be used to control electric lights and other devices in response to people entering into a room.

The invention relates to alarm systems, and in particular to an alarm system designed to protect an enclosed space and give warning that the space has been penetrated by an intruder. It is based on U.S. Provisional Patent Application No. 60/842,522 filed on Sep. 6, 2006.

### BACKGROUND OF THE INVENTION

An intrusion alarm is typically intended to protect an enclosed space from intrusion. The space may be a domestic dwelling or commercial building, a room in such a building, a safe, a vault, or the interior of a vehicle.

It is a well known fact that air pressure in an enclosed space will remain unchanged as long as that space remains fully enclosed. When the space develops an opening, air pressure changes depending on the outside air pressure. If the enclosed space is a room in a building, air pressure inside will remain either constant or will change slowly in accordance with the outside atmospheric pressure. Opening of doors and windows would result in a rapid fluctuation of the air pressure in the room. This can be detected by an appropriate sensor.

In U.S. Pat. No. 3,947,838 there is described an alarm system comprising a moving vane sensor responsive to air pressure within an enclosed space, the sensor providing electrical signals related to the sensed air pressure, and a signal processor to which the electrical signals are supplied and operative to initiate an alarm indication when the signal supplied by the sensor is indicative of an intrusion into the enclosed space.

The U.S. Pat. No. 4,692,734 issued to Holden et al. describes the signal processing in the alarm system based on a comparison of the current signal with the reference set.

The prior art relies on use of either complex pressure sensors, or the pressure sensors are not sufficiently sensitive to detect as small pressure variations as few mm H₂O.

It is therefore the object of this invention to develop a sensor for the security alarm system that is sensitive to detect small changes in pressure;

It is another object of this invention to make pressure sensor insensitive to slow changing air pressure.

And another object of this invention is to reduce a complexity and cost the air pressure sensor.

### SUMMARY OF THE INVENTION

According to this invention an alarm system comprises a sensor responsive to air pressure changes within an enclosed space. The sensor contains a thin and relative large membrane with one side exposed to the air in a monitored enclosed space, while the opposite side of the membrane is enveloped by an enclosure having a small hole that is exposed to the same monitored enclosed space. The hole restricts the air flow between the interior of the enclosure and the outside, thus resulting in a delay between the variations in pressure inside and outside of the enclosure. The delay causes a temporary disbalance of pressures across the membrane and thus the membrane deflection. The deflection is measured by the displacement sensor, for example, optical. The output signal of the displacement sensor is further compared with a predetermined threshold whose output, in turn, controls the alarm.

### DESCRIPTION OF THE DRAWINGS

This invention will now be described by way of example with reference to the drawings, in which:

FIG. 1 is an example of an enclosed space with a door and windows;

FIG. 2 shows variations in air pressure within the enclosed space;

FIG. 3 is a cross-sectional view and block-diagram of the differential air pressure sensor and the alarm system;

FIG. 4. shows operation of the optical displacement detector;

FIG. 5 depicts a timing diagram of pressures across the membrane, and

FIG. 6 shows an opening in the enclosure with a variable aperture.

FIG. 7 illustrates a capacitive option of the displacement sensing, and

FIG. 8 depicts a corrugated membrane.

### DESCRIPTION OF THE PREFERRED EMBODIMENT

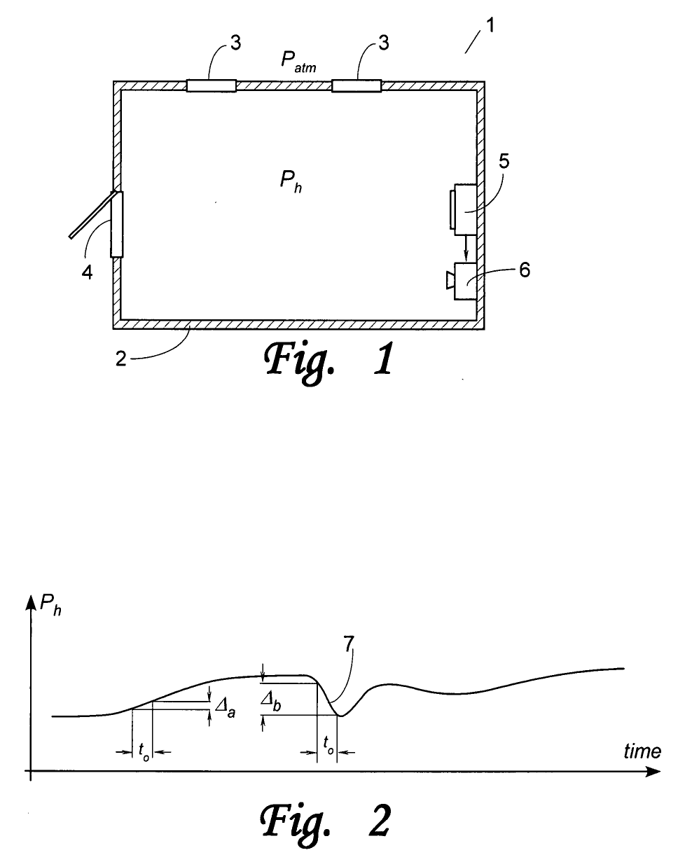

The system shown in FIG. 1 comprises a sensor 5 which is arranged in an enclosed space 1 to be monitored and responsive to the air pressure in that space to provide electrical signals indicative of the air pressure variations at any time. The sensor 5 is connected to the monitor 6 that may be comprised of a microprocessor, alarm, power source and other components. The enclosed space 1 has windows 3 and one or more doors 4. The interior air pressure is Pₕ and the exterior pressure is atmospheric Pₐₜₘ. Generally, these pressures are somewhat different, primarily due to a temperature gradient between the enclosed space and the outside. When the doors and windows are closed, still some air leaks may be present and pressure Pₕ would change rather slowly along with Pₐᵢₘ. When doors 4 or windows 3 are opened and closed, air flow (draft) occurs and pressure Pₕ changes more rapidly towards equalization with Pₐᵢₘ. The same effect occurs when people enter the enclosed space and move within the space. This is illustrated in FIG. 2 that shows the internal air pressure. When it changes slowly, the changes Δₐ are smaller than Δ_{b} which occur during the rapid pressure variations. The time to is a fixed interval to measure the pressure variations. The purpose of sensor 5 is to respond to faster changes in pressure and not to respond to slower changes in pressure. It also should be noted that air drafts caused by movement of intruders may be quite small—typically not greater than few mmH₂O.

A differential pressure sensor 5 is shown in FIG. 3. Unlike the conventional differential pressure sensors that respond to constant and changing pressures, the illustrated sensor responds only to relatively fast changes in the gas pressure differential and is not sensitive to slow changing pressures. A goal of the sensor is to convert the differential air (gas) pressure changes to the output electrical signal that can be processed by the signal conditioner 20, processor 22 and activate the alarm 23, if needed. In this example of the design, the printed circuit board (PCB) 10 supports membrane 13 which is air-tight sealed to the PCB 10 all around the circumference at areas 14 and 15. The PCB acts as a support structure. The membrane is fabricated of any suitable material, such as Mylar, aluminum or brass foil and is stretched reasonably tight. It must be flexible enough to respond to small variations in pressure across its thickness. A shape of the membrane 13 may be a disk having a diameter from 0.25 to 4 inch and thickness between 0.0005 and 0.005 of an inch. The membrane may be flat or corrugated as shown in FIG. 8 where the creases 46 may have a circular shape.

Next to the membrane 13, the PCB 10 has an opening 11 which is smaller than the membrane overall size. An inlet tube 12 is attached to the PCB 10 to allow air pressure Pₕ to access the membrane 13 through the opening 11. At the opposite side of the PCB 10, there is an enclosure 16 which is air-tightly attached to the PCB 10. The membrane 13 has two sides: side 50 is exposed to the protected space, while side 51 is exposed to enclosure 16. In other words, membrane 13 at the left side 50 is exposed to the monitored pace air pressure Pₕ, while at the right side 51 it is exposed to the air pressure P₂ inside the enclosure 16. The enclosure 16 has at least one hole 17 whose aperture may be either fixed or adjusted by a moving cover 34 as illustrated in FIG. 6. The cover 34 may be rotated around pivot 35. In general, the area of aperture of the hole 17 shall be at least 100 times smaller than the overall inner surface area of the enclosure 16 or the membrane 13.

In the first preferred embodiment, at one of the sides of the membrane 13, for example at side 51, there is a displacement sensor 18 as illustrated in FIG. 3. The purpose of the displacement sensor 18 is to detect the membrane 13 displacement, that is, to convert distance 19 to the membrane 13 into electrical signal that can be processed by the signal conditioner 20. The membrane 13 displacement is the measure of a differential pressure ΔP.

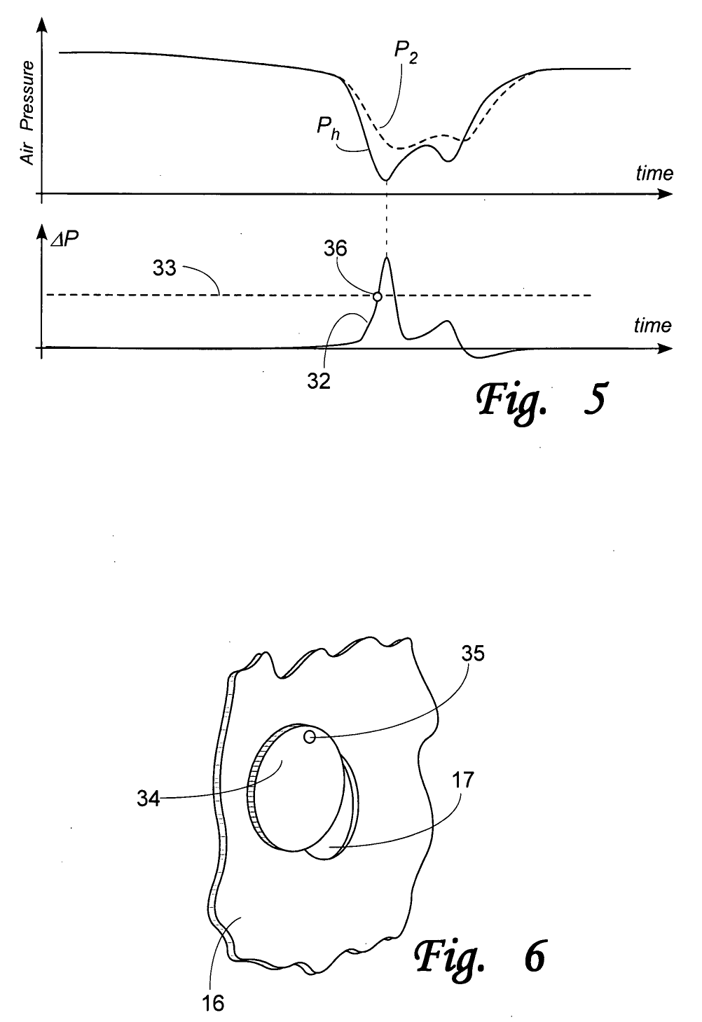

Since the enclosure 16 is connected to the protected space only through a small hole 17, changes in air pressure Pₕ are not immediately reflected by the internal pressure P₂. In other words, there is a phase shift between the outside and the inside pressures, as illustrated in FIG. 5. When Pₕ changes slowly, a small hole 17 allows P₂ to follow Pₕ very closely so pressures at both sides of membrane 13 are nearly the same and the membrane is substantially flat and not moving. During faster changes in Pₕ, the hole 17 slows down the pressure equalization and the internal pressure P₂ (dotted line in FIG. 5) lags behind and also is somewhat smoother. A differential pressure ΔP across the membrane 13 is shown at the bottom portion of FIG. 5 as pressure 32. When the differential pressure 32 is near zero, the membrane remains substantially flat and the distance 19 is at its base level. When pressure 32 deflects from zero, the membrane 13 flexes inwardly or outwardly, thus modulating distance 19.

The displacement sensor 18 monitors this distance 19 and provides a signal to the signal conditioner. When the pressure differential ΔP and, subsequently, the distance 19 are sufficiently large to reach the preset threshold 33, the processor 22 detects the threshold crossing 36 and indicates the alarming event.

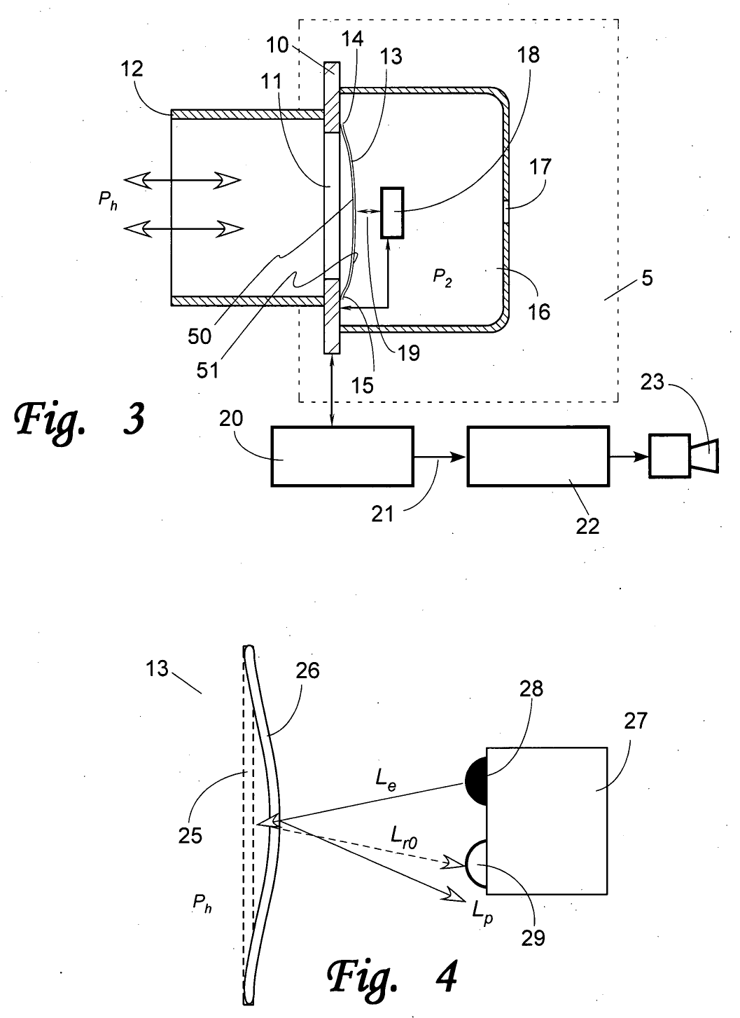

There are numerous ways of designing a displacement sensor. FIG. 4 illustrates one possible way of designing the displacement sensor 18. It is comprised of an opto-coupler 27 with the photo emitter 28 and photo detector 29. The membrane 13 is shown in two states: the base state 25 which corresponds to a zero differential pressure, and a flexed state 26 when Pₕ is higher than P₂. The right side of membrane 13 is made reflective. For example, if the membrane is made of a plastic film, like Mylar, at least one side can be metallized. When the membrane 13 is in state 25, the emitted light Lₑ is reflected from the membrane and goes to the detector 29 as the beam Lᵣ₀. The output signal from the opto-coupler 27 is the strongest. When the membrane 13 moves to the state 26, the reflected light beam Lₚ is diverted from the detector 29, causing the opto-coupler's output signal to drop. To minimize the opto-coupler power consumption, the emitted light doesn't need to be continuous, it can be emitted as short pulses with a small duty cycle. For example, a light pulse can have a duration of 10 microseconds and the pulses are emitted with a rate of 100 pulses per second. This corresponds to a duty cycle of 0.001 which results in a significant reduction in power consumption without compromising reliability of the intrusion detection.

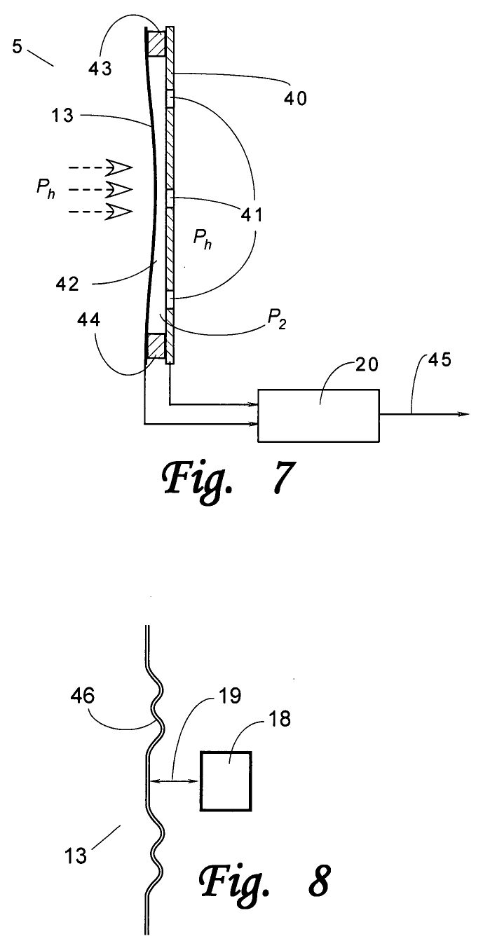

In the second embodiment, the function of a displacement sensor may be assumed by the signal conditioner 20 that should be responsive to changes in a capacitance. In this case, the enclosure 16 is replaced by a substantially flat and rigid plate 40 shown in FIG. 7. The disk has at least one and possibly several small holes 41 whose combined area of aperture shall be at least 100 times smaller than area of the plate 40 adjacent to the membrane. The plate 40 is positioned close to membrane 13 and is separated from it by a spacer 43, 44. The gap 42 between the membrane 13 and plate 40 should be no larger than 0.1 of an inch. The plate 40 shall be electrically conductive and at least one side of membrane 13 also shall be electrically conductive. An electrical capacitance is formed between the membrane 13 and plate 40. A value of this capacitance will change when pressure Pₕ varies with respect to the air pressure P₂ inside the gap 42. The capacitance variations are measured by the signal conditioner 20 and presented as the output 45 reflecting the differential pressure ΔP.

One should not overlook other potential applications of the above described differential pressure detector. These may include turning on electric lights in a room in response to an intrusion or walking near the detector. This can be exemplified by a stairway that needs to be illuminated. Traditional infrared motion detectors that are used for this purpose respond only when there is a direct vision of the intruder, while the differential air pressure detector would have a coverage not limited by a direct line of view. In such applications, an alarm 23 of FIG. 3 is replaced with an electric switch.

Without further elaboration, the foregoing will so fully illustrate our invention that others may, by applying current or future knowledge, readily adopt the same for use under various conditions of service.

1. A detector of a variable gas pressure in a monitored space comprising
the membrane having first side and second side, wherein the first side is exposed to a monitored space filled with gas, such membrane is being attached to a support structure;
the enclosure adjacent to the second side of said membrane to envelop a volume of gas near the second side of the membrane;
a hole being formed in said enclosure to pneumatically connect the enveloped volume of gas within said enclosure to the monitored space.

2. A detector of a variable gas pressure of claim 1 where said hole has a cross-sectional area at least 100 times smaller than the inner surface area of said enclosure.

3. A detector of a variable gas pressure of claim 1 where said membrane has at least one side being composed of metal.

4. A detector of a variable gas pressure of claim 1 further comprising a displacement sensor being responsive to movement of said membrane.

5. A detector of a variable gas pressure of claim 1 further comprising a support structure being attached to said enclosure;

6. A detector of a variable gas pressure of claim 1 where said hole has an adjustable aperture.

7. The intrusion alarm comprising a detector of a variable air pressure, a signal processing circuit and an alarm, wherein said detector of a variable air pressure is more responsive to faster changes in the air pressure and less responsive to slower changes in the air pressure.

8. The intrusion alarm of claim 7 where said signal processing circuit further comprises a threshold detector responsive to a difference between the faster changes in the air pressure and slower changes in the air pressure.

9. An electric switch that closes the electric circuit in response to variations air pressure in a monitored space, comprising in combination
a differential air pressure detector being comprised of a membrane having two sides, where one side is directly exposed to air in the monitored space, while the other side is exposed to air in the monitored space through a hole being smaller than the membrane;
a signal conditioning circuit for processing signals from said differential air pressure detector;
a threshold detector;
an electric switch being controlled by said threshold detector
